(19) United States
(12) Patent Application Publication
(10) Pub. No.: US 2009/0034113 A1
(43) Pub. Date: Feb. 5, 2009

(54) Disk device and electronic equipment using the same

(76) Inventors: Hideyuki Hashi, Osaka (JP); Hideki Kuwajima, Kyoto (JP)

Correspondence Address: RATNERPRESTIA, P.O. BOX 980, VALLEY FORGE, PA, 19482, US

(21) Appl. No.: 10/584,683

(22) PCT Filed: Oct. 19, 2005
(86) PCT No.: PCT/JP05/19194

§ 371 Date: Jun. 28, 2006

(30) Foreign Application Priority Data
Oct. 21, 2004 (JP) 2004-306651

(51) Int. Cl. G11B 21/02

(52) U.S. Cl. 360/75; G9B/21.003

(57) ABSTRACT

It is equipped with a magnetic recording medium, a spindle motor which rotates the magnetic recording medium, ahead portion which carries out at least any one of recording and reproducing of information, an actuator which supports the head portion, a voice coil which turns the actuator, a relay wiring body which is electrically connected to the head portion and the voice coil, and a motor wiring body which is electrically connected to the spindle motor, and a housing is equipped with a connector by which the relay wiring body and the motor wiring body are electrically connected in the housing for giving and receiving an electric signal between the relay wiring body and the motor wiring body and a control section.

### TECHNICAL FIELD

This invention relates to a disk device which is equipped with a floating type signal conversion element, and more particularly, relates to a disk device which is controlled by a control section disposed outside a housing of a disk device, and an electronic equipment using it.

### BACKGROUND ART

A magnetic disk device such as a hard disk device has become mounted even on a portable small-size electronic equipment such as a portable telephone device and a portable audio player device, depending on a rapid miniaturization/realization of large capacity in recent years. By further miniaturization and realization of low cost from now on, it is expected that an application to these electronic devices will be extended.

In the suchlike magnetic disk device, as a point for realizing further miniaturization and low cost, there is a wiring structure for carrying out giving and receiving a signal between a magnetic head, a spindle motor and an actuator and a control section.

Firstly, a wiring connection method in a conventional disk device will be explained. Here, the explanation will be carried out by use of a magnetic device such a hard disk device as one example of the disk device.

FIG. 14 is a plan view showing such a situation that an upper side chassis was removed in conventional magnetic disk device 130 having a floating type signal conversion element (hereinafter, simply described as a magnetic head), and FIG. 15A is a partial cross sectional view which shows a cross section of conventional disk device 130 at a P-P line in FIG. 14, and FIG. 15B is a partial cross sectional view which shows a cross section of conventional disk device 130 at a Q-Q line in FIG. 14.

In FIGS. 14, 15A and 15B, actuator 131 has suspension 132 with relatively low stiffness, plate spring portion 133 and support arm 134 with relatively high stiffness. On a lower surface of an one end side of suspension 132, head slider 135, on which a magnetic head (not shown in the figure) was mounted, is disposed.

In addition, it is configured in such a manner that magnetic recording medium 136 is rotated by spindle motor 137, and at the time of recording and reproducing of magnetic disk device 130, depending on rotation of magnetic recording medium 136, levitation force which is received by head slider 135 by an air flow that is generated between head slider 135 and magnetic recording medium 136, bias force due to plate spring portion 133 of actuator 133 which biases head slider 135 to magnetic recording medium 136 (so-called load loading) balance out, and head slider 135 is floated from magnetic recording medium 136 with given quantity, and a magnetic head is also floated from magnetic recording medium 136 with give quantity.

Actuator 131 turns around turning shaft 139 as a center at the time of recording and reproducing of magnetic disk device 130, by an operation of voice coil 138 disposed at an end portion of support arm 134 which is opposite to such a side that head slider 135 is disposed. By this means, a magnetic head, which is mounted on head slider 135, is positioned against a desired track in magnetic recording medium 136, and magnetic disk device 130 is capable of carrying out recording and reproducing.

At the time that magnetic disk device 130 stops, actuator 131 turns around turning shaft 139 as a center and moves toward an outside of magnetic recording medium 136. On the outside of magnetic recording medium 136, head holding portion 140 is disposed, and guide portion 132a, which is formed on a front edge of suspension 132, runs on taper portion 140a formed on head holding portion 140, and thereby, it is possible to prevent absorption of head slider 135 supported by suspension 132 and the magnetic head and magnetic recording medium 136.

In addition, in conventional magnetic disk device 130, spindle motor 137, turning shaft 139 of actuator 131 and head holding portion 140 are attached to lower side chassis 143, respectively.

Further, in conventional magnetic disk device 130, in order to supply an electric signal for controlling rotation of spindle motor 137 from electric circuit main substrate 146 which will be described later, motor wiring body 141 using, for example, a flexible wiring substrate (FPC substrate) is disposed on spindle motor 137. In addition, for the purpose of giving and receiving a recording signal or a reproducing signal between electric circuit main substrate 146 and a magnetic head of actuator 131 and giving and receiving a control signal between electric circuit main substrate 146 and voice coil 138 for positioning the magnetic head at a predetermined position on magnetic recording medium 136, actuator wiring body 142 using, for example, the FPC substrate is disposed on actuator 131.

Further, for the purpose of dust control etc., upper side chassis 144 is attached to lower side chassis 143 so as to cover internal each constituent element to seal it hermetically.

In addition, in conventional magnetic disk device 130, electric circuit main substrate 146, on which electric circuit components 145 for controlling magnetic disk device 130 are mounted, as shown in for example, FIG. 15A or 15B, is attached to a bottom surface of lower side chassis 143.

On electric circuit main substrate 146, motor connector 147 and actuator connector 148 are disposed, and connector 141a of motor wiring body 141 is connected to motor connector 147, and connector 142a of actuator wiring body 142 is connected to actuator connector 148.

In this manner, conventional disk device 130 was configured in such a manner that a control signal from electric circuit main substrate 146 is sent through motor connector 147 to spindle motor 137, and is sent through actuator connector 148 to a magnetic head or voice coil 138 (e.g., see, Japanese Patent Unexamined Publication No. 4-181587, or Japanese Patent Unexamined Publication No. 7-14362).

However, in the above-described conventional magnetic disk device, two connectors, i.e., the motor connector for signal transmission to the spindle motor and the actuator connector for signal transmission to the magnetic head or the voice coil, are required, and a space for that arrangement is enlarged, and therefore, there was such a problem that miniaturization of an entire device is difficult.

Further, sealing means for securing air tightness of an inside in a magnetic disk device is required for the motor wiring body and the actuator wiring body, respectively, and therefore, there was such a problem that cost goes up.

### DISCLOSURE OF THE INVENTION

A disk device of the present invention is a disk device which is equipped with a housing; a disk-shaped recording medium, a rotating portion which rotates the recording medium, a head portion which carries out at least any one of recording and reproducing of information to the recording medium, an actuator portion which supports the head portion and can be turned in a radius direction of the recording medium, a turning portion which turns the actuator portion so as to dispose the head portion on the recording medium at a desired position, a first wiring body which is connected to the head portion and the turning portion electrically, and a second wiring body which is connected to the rotating portion electrically, in the housing; and is equipped with a control section, which carries out control of the rotating portion, the head portion and the turning portion, outside the housing, wherein the first wiring body and the second wiring body are electrically connected in the housing, and wherein a terminal is disposed on the housing for giving and receiving an electronic signal between the first wiring body, the second wiring body and the control section.

By the suchlike configuration, since the first wiring body and the second wiring body are electrically connected and connection to an outside is carried out by one terminal portion, there is no problem even if its arrangement space is small, and therefore, it is suitable for miniaturization, and further, since there is no problem even if sealing means for securing air tightness of an inside is carried out at one place, cost reduction becomes possible, and it is possible to realize a low cost disk device.

In addition, the disk device may be configured in such a manner that the first wiring body has a connecting portion for being electrically connected to the second wiring body, and the second wiring body has an electrically conductive portion for being electrically connected to the connecting portion of the first wiring body, at its end portion, and a pressing portion, which presses in a direction of having the connecting portion of the first wiring body accessed to the electrically conductive portion of the second wiring body, is provided, and the connecting portion of the first wiring body and the electrically conductive portion of the second wiring body are brought into contact, by pressing of the pressing portion, and the first wiring body and the second wiring body are connected electrically.

According to the suchlike configuration, it is further possible to electrically connect the first wiring body and the second wiring body by contacting the connecting portion of the first wiring body and the electrically conductive portion of the second wiring body through the use of the pressing portion, and therefore, even in case of disassembling a disk device which was assembled once, due to failure etc., it is possible to realize a configuration with excellent re-work characteristic, as compared with such a case that it is fixed by solder etc.

In addition, the disk device may be configured in such a manner that the first wiring body has an amplification circuit of a signal which is outputted from the head portion.

According to the suchlike configuration, it is further possible to process a minute signal in the vicinity of the head portion, and therefore, it is possible to realize a configuration with high reliability by which it is possible to suppress occurrence of noises and it is possible to give and receive a signal stably.

In addition, the disk device may be configured in such a manner that width W₁ and width W₂ are different in such a portion that the connecting portion of the first wiring body and the electrically conductive portion of the second wiring body contact.

According to the suchlike configuration, it is further possible to obtain favorable conducting even in case that positions of the connecting portion of the first wiring body and the electrically conductive portion of the second wiring body are deviated due to vibration etc., and it is possible to realize a configuration with excellent impact resistance.

Further, the disk device may be configured in such a manner that width W₁ of the connecting portion and width W₂ of the electrically conductive portion have a relation of

W₁<W₂.

According to the suchlike configuration, further, even if a center of width W₁ of the connecting portion of the first wiring body and a center of width W₂ of the electrically conductive portion of the second wiring body are slightly deviated, respectively, certainty of contact is improved, and there is not such a case that displacement on the occasion of mounting brings about obstacles to giving and receiving an electric signal, and it is possible to keep a contact situation between them in a favorable manner.

Further, the disk device may be configured in such a manner that gold plating is formed on surfaces of the connecting portion and the electrically conductive portion, respectively, in such a portion that the connecting portion of the first wiring body and the electrically conductive portion of the second wiring body contact.

According to the suchlike configuration, it is further possible to make contact resistance nearly 0Ω in the contact portion of the connecting portion of the first wiring body and the electrically conductive portion of the second wiring body. In addition, even if contact pressure of the connecting portion of the first wiring body and the electrically conductive portion of the second wiring body is changed due to impact, vibration etc. from an outside, as long as contact is maintained, there is no such a case that the contact resistance is changed significantly, and stable signal giving and receiving becomes possible.

In addition, the disk device may be configured in such a manner that the pressing portion is formed by an elastic material, and has a plurality of bifurcated front edge portions, and the front edge portion presses the connecting portion of the first wiring body.

According to the suchlike configuration, it is further possible to realize a configuration which is capable of pressing the connecting portion of the first wiring body effectively, by such a simple method that the pressing portion is formed by an elastic material.

In addition, the disk device may be configured in such a manner that the front edge portion of the pressing portion is of such a shape that a cross sectional area of a portion of a front edge is made smaller than a cross sectional area of a portion of a root.

According to the suchlike configuration, it is further possible to restrain weakening of pressing force for pressing the connecting portion of the first wiring body, by the force from an outside such as impact, especially rotation impact, and therefore, even if rotation impact etc. are experienced, it is possible to maintain a stable contact situation between the connecting portion of the first wiring body and the electrically conductive portion of the second wiring body, and it is possible to carry out stable giving and receiving of a signal, and therefore, it is possible to realize a disk device having high impact resistance.

Further, the disk device may be configured in such a manner that the pressing portion has a base material portion using a flat member, a plurality of bifurcation portions which are disposed on the base material portion, and elastic portions at portions of front edges of the respective plural bifurcation portions.

According to the suchlike configuration, it is further possible to realize a configuration which is capable of pressing the connecting portion of the first wiring body effectively, by such a simple method that an elastic portion is formed on a front edge of a flat plate.

In addition, the disk device may be configured in such a manner that each of the plural bifurcation portions of the pressing portion is of such a shape that a cross sectional area of a portion of a front edge is made smaller than a cross sectional area of a portion of a root.

According to the suchlike configuration, it is further possible to restrain weakening of pressing force for pressing the connecting portion of the first wiring body, by the force from an outside such as impact, especially rotation impact, and therefore, even if rotation impact etc. are experienced, it is possible to maintain a stable contact situation between the connecting portion of the first wiring body and the electrically conductive portion of the second wiring body, and it is possible to carry out stable giving and receiving of a signal, and therefore, it is possible to realize a disk device having high impact resistance.

In addition, the disk device may be configured in such a manner that the first wiring body is folded and thereby, the pressing portion is sandwiched. According to the suchlike configuration, it is possible to mount much more components, by folding the first wiring body even in a limited space, and therefore, miniaturization of an entire device is possible.

In addition, the disk device may be configured in such a manner that the terminal portion is disposed on the first wiring body, and a wiring from the second wiring body and a wiring from the head portion and the turning portion are formed integrally on the first wiring body.

According to the suchlike configuration, it is further possible to realize a configuration with easy to use and excellent productivity, since two wirings and the terminal are disposed on the first wiring body.

Further, the disk device may be configured in such a manner that a ground line portion is provided on the first wiring body between the wiring from the second wiring body and the wiring from the head portion and the turning portion.

According to the suchlike configuration, it is further possible to suppress cross talk which is generated between two wirings which are connected to the terminal portion.

Further, the disk device may be configured in such a manner that the housing is equipped with a first housing to which the first wiring body and the pressing portion are attached, and a second housing to which the rotating portion and the second wiring body are attached, and by assembling the first housing and the second housing, the first wiring body and the second wiring body are brought into contact, and the first wiring body is pressed to the second wiring body due to biasing force of the pressing portion, and thereby, the first wiring body and the second wiring body are connected electrically.

According to the suchlike configuration, further, the connecting portion of the first wiring body, which is pressed by the pressing portion, is brought into contact with the electrically conductive portion of the second wiring body, by assembling the first housing and the second housing, and it is possible to easily form electric connection between the first wiring body and the second wiring body, and it is possible to realize very high assembly workability. Further, even in case that it is necessary to disassemble on the occasion that failure etc. occurred, if the second housing is removed from the first housing, contact of the connecting portion of the first wiring body and the electrically conductive portion of the second wiring body is released, and it is possible to easily separate the rotating portion and the turning portion, and therefore, it is possible to shorten working hours for a disassembling work, and it is possible to realize very high disassembly workability.

Next, an electronic equipment of the present invention is characterized by being equipped with a disk device of the present invention.

According to the suchlike configuration, since the first wiring body and the second wiring body are electrically connected and connection to an outside is carried out by one terminal portion in the disk device, there is no problem even if its arrangement space is small, and therefore, it is suitable for miniaturization, and further, since there is no problem even if sealing means for securing air tightness of an inside is carried out at one place, cost reduction becomes possible, and it is possible to realize a low cost electronic equipment.

In addition, the electronic equipment may be configured in such a manner that a control section is disposed on the side of the electronic equipment.

According to the suchlike configuration, it is further possible to carry out connection of the control section which is disposed on the side of the electronic equipment and the disk device through one terminal portion, and therefore, it becomes possible to carry out connection simply.

As described above, according to a disk device and an electronic equipment using it of the present invention, it is possible to carry out connection to an outside by one connection, and therefore, it is possible to realize miniaturization and low cost of an entire device.

### BRIEF DESCRIPTION OF THE DRAWINGS

FIG. 1 is a plan view which shows a major configuration of a magnetic disk device in an embodiment of the present invention.

FIG. 2 is an expansion plan view which shows a configuration of a relay wiring body of the magnetic disk device in the embodiment of the present invention.

FIG. 3A is a side view on the occasion that the relay wiring body of the magnetic disk device in the embodiment of the present invention is assembled.

FIG. 3B is a side view in which a portion of a R portion in FIG. 3A of the magnetic disk device in the embodiment of the present invention is enlarged.

FIG. 3C is a cross sectional view of a FPC post of the magnetic disk device in the embodiment of the present invention.

FIG. 4A is a plan view which shows a configuration of a pressing elastic member of the magnetic disk device in the embodiment of the present invention.

FIG. 4B is a side view of the pressing elastic member of the magnetic disk device in the embodiment of the present invention.

FIG. 5A is a partial cross sectional view which shows a cross section, at an A-A line in FIG. 1, of the magnetic disk device in the embodiment of the invention.

FIG. 5B is a partial cross sectional view which shows a cross section, at a B-O₁-O₂-O₃-B line in FIG. 1, of the magnetic disk device in the embodiment of the invention.

FIG. 6 is a partial cross sectional view which shows a cross section, at a C-O₄-C line in FIG. 1, of the magnetic disk device in the embodiment of the invention.

FIG. 7 is a partial cross sectional view of vicinity of a contact portion of a relay wiring body and a motor wiring body, of the magnetic disk device in the embodiment of the present invention.

FIG. 8 is a perspective view which shows a configuration of an assembly jig on the occasion of assembling the magnetic disk device in the embodiment of the present invention.

FIG. 9A is a plan view for explaining processes of assembling the magnetic disk device in the embodiment of the present invention.

FIG. 9B is a plan view for explaining processes of assembling the magnetic disk device in the embodiment of the present invention.

FIG. 10A is a plan view for explaining processes of assembling the magnetic disk device in the embodiment of the present invention.

FIG. 10B is a plan view for explaining processes of assembling the magnetic disk device in the embodiment of the present invention.

FIG. 11A is a plan view for explaining processes of assembling the magnetic disk device in the embodiment of the present invention.

FIG. 11B is a plan view for explaining processes of assembling the magnetic disk device in the embodiment of the present invention.

FIG. 12 is a partial perspective view which shows another example of the pressing elastic member of the magnetic disk device in the embodiment of the present invention.

FIG. 13 is a block diagram which shows a configuration of an electronic equipment on which the magnetic disk device in the embodiment of the present invention is mounted.

FIG. 14 is a plan view showing such a situation that an upper side chassis is removed in a conventional magnetic disk device having a floating type signal conversion element.

FIG. 15A is a partial cross sectional view which shows a cross section, at a P-P line in FIG. 14, of the conventional magnetic disk device.

FIG. 15B is a partial cross sectional view which shows a cross section, at a Q-Q line in FIG. 14, of the conventional magnetic disk device.

### DESCRIPTION OF REFERENCE NUMERALS AND SIGNS

1 spindle motor
1a motor wiring body (second wiring body)
1b,21b electrically conductive portion
2 rotating center shaft
3 magnetic recording medium
4 turning shaft
5 actuator (head supporting device)
5a actuator wiring body
5b tab portion
5c signal wiring connecting portion
6 ramp block
6a,51a,51b,51c protruding portion
6b,9e,21d,21e positioning hole
7 relay wiring body (first wiring body)
7a preamplifier circuit portion
8 voice coil
9,93 pressing elastic member
9a flat surface portion
9b front edge portion
9c,9d,9f,9g,10a,21c,31a,31b,52a through-hole
10 lower side chassis
11 magnetic disk device
21 flexible wiring substrate (FPC substrate)
21a,91 base material portion
22 electric circuit component
23,54 connector
24 gasket
25 connecting portion
31 reinforcing plate
32 FPC post
32a,61a screw portion
32b,32c,61b,61c circular cylindrical portion
32d,61e step surface
32e corner portion
41a,41b width
51 spacer
52 upper side chassis
53 electric circuit main substrate
55 ground line portion
56,57 wiring
61 ramp post
61d flange portion
62, 63 screw
71 HDA portion
72,76 disk unit
73 control section
74,77 electronic equipment
75 electronic equipment circuit section
81 assembly jig
82,83,84 positioning post
85 substrate
91a bifurcation portion
92 elastic portion
106 clearance hole

### BEST MODE FOR CARRYING OUT THE INVENTION

Hereinafter, an embodiment of the present invention will be explained in detail by use of drawings.

### Embodiment

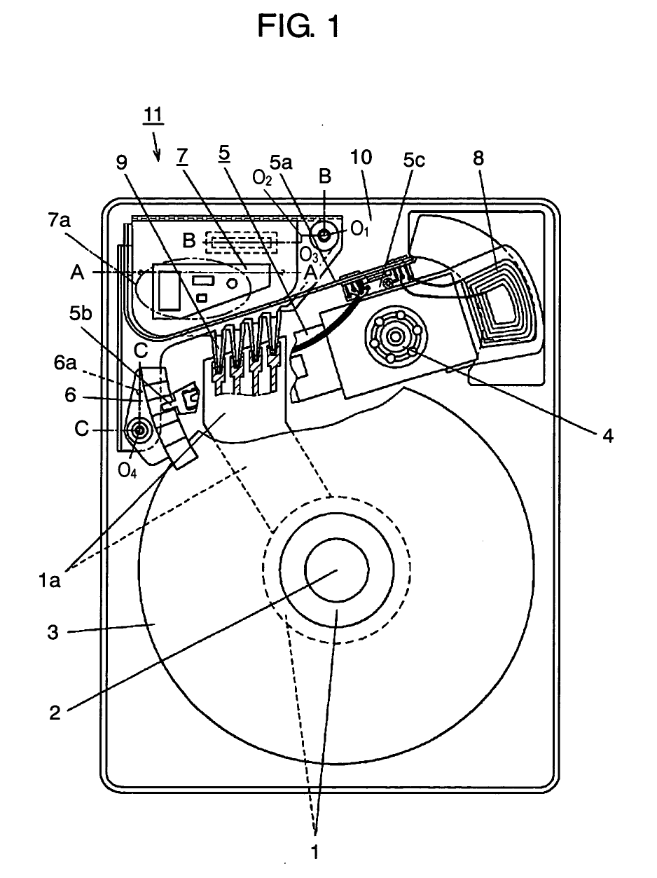

A magnetic disk device in an embodiment of the present invention will be explained by use of drawings from FIG. 1 to FIG. 13.

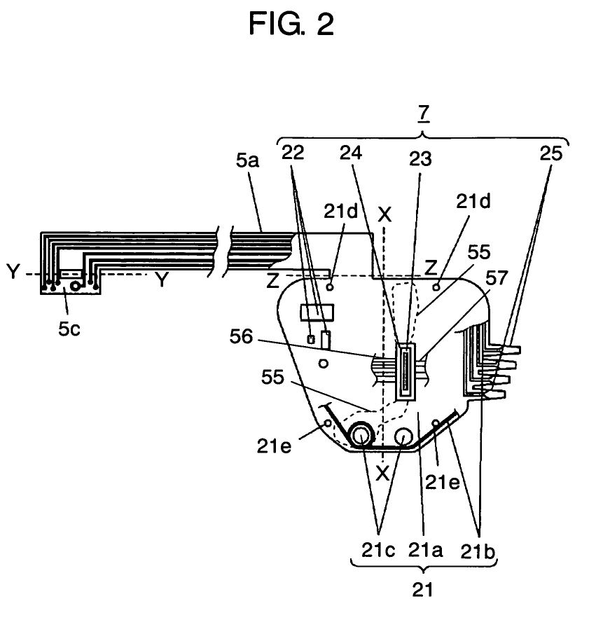

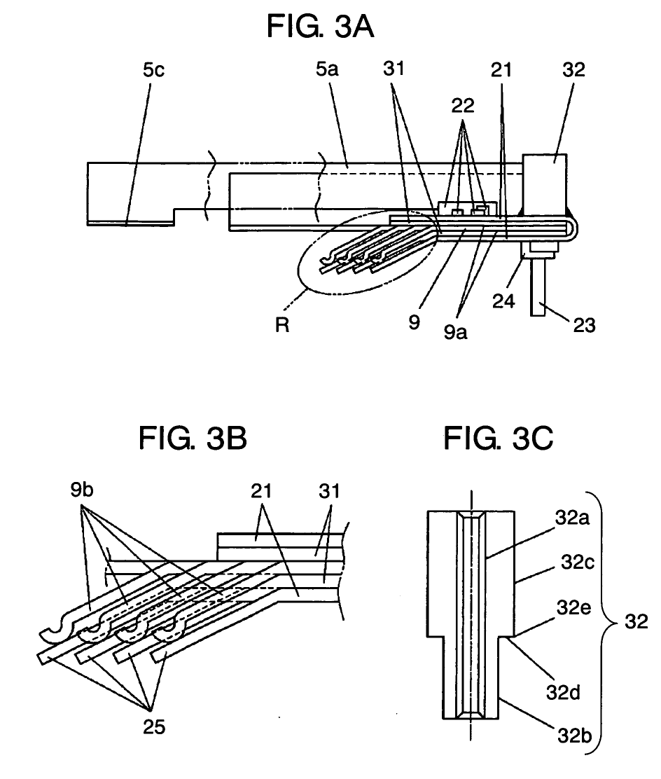

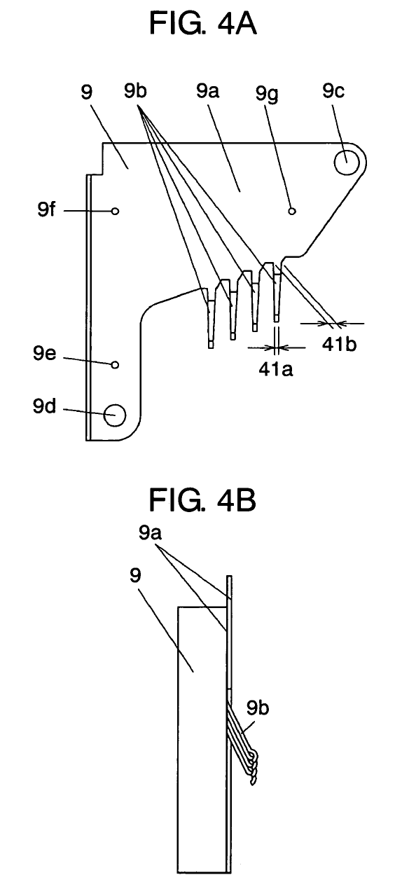

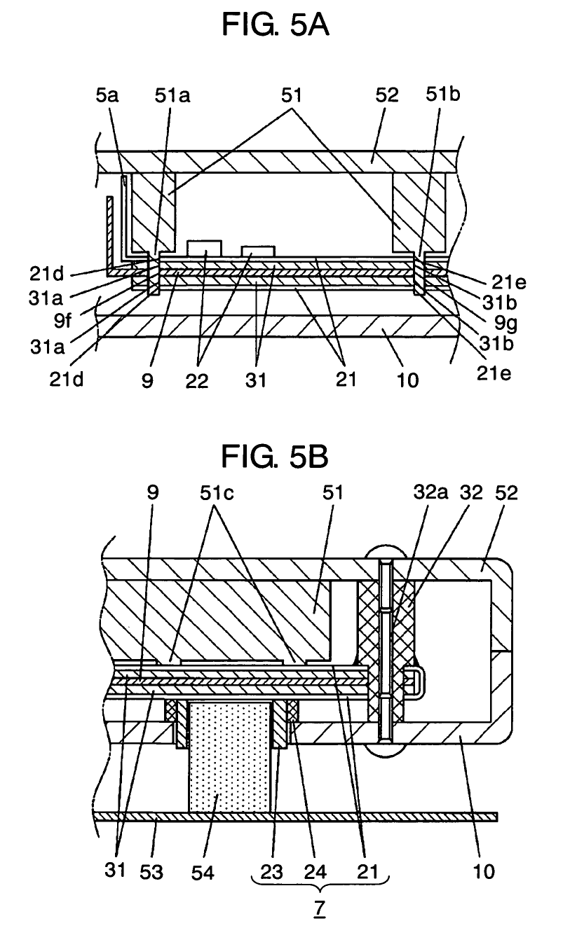

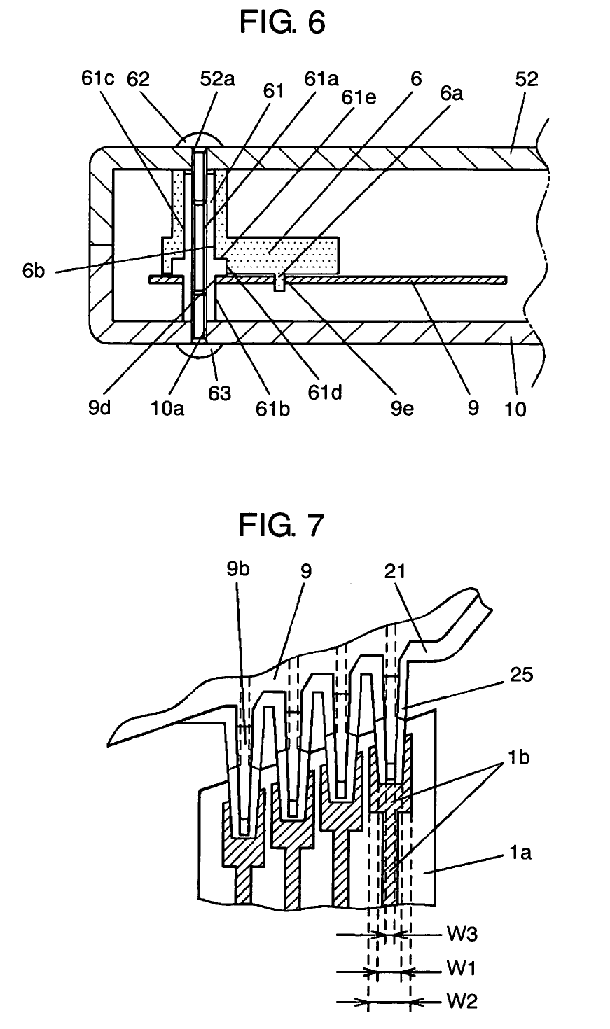

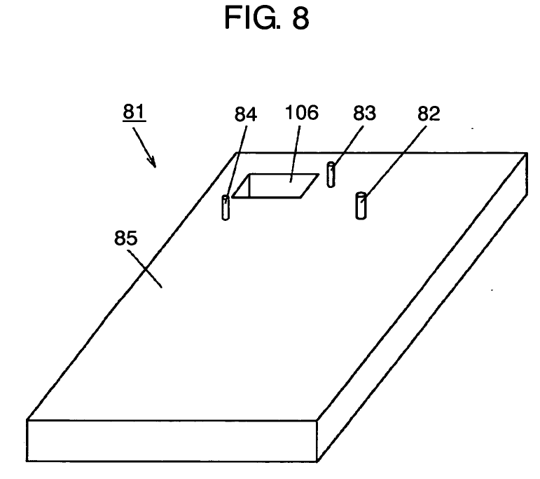

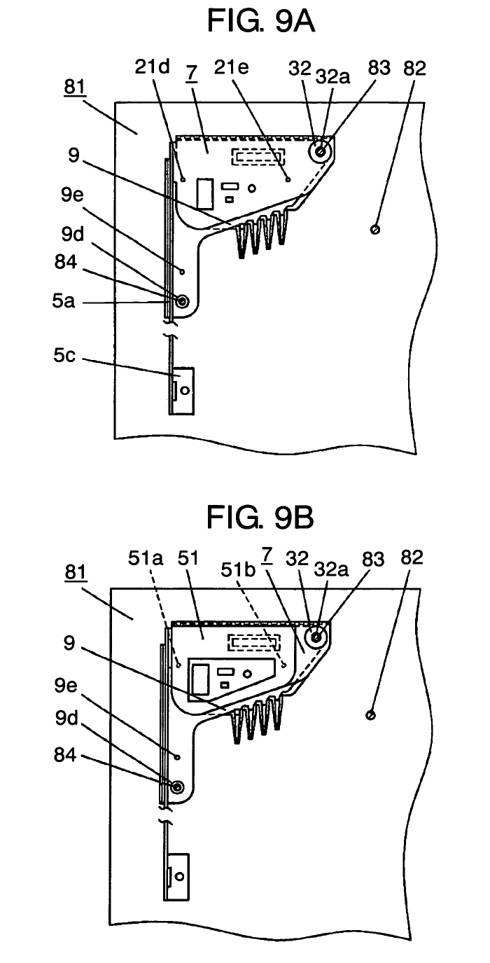

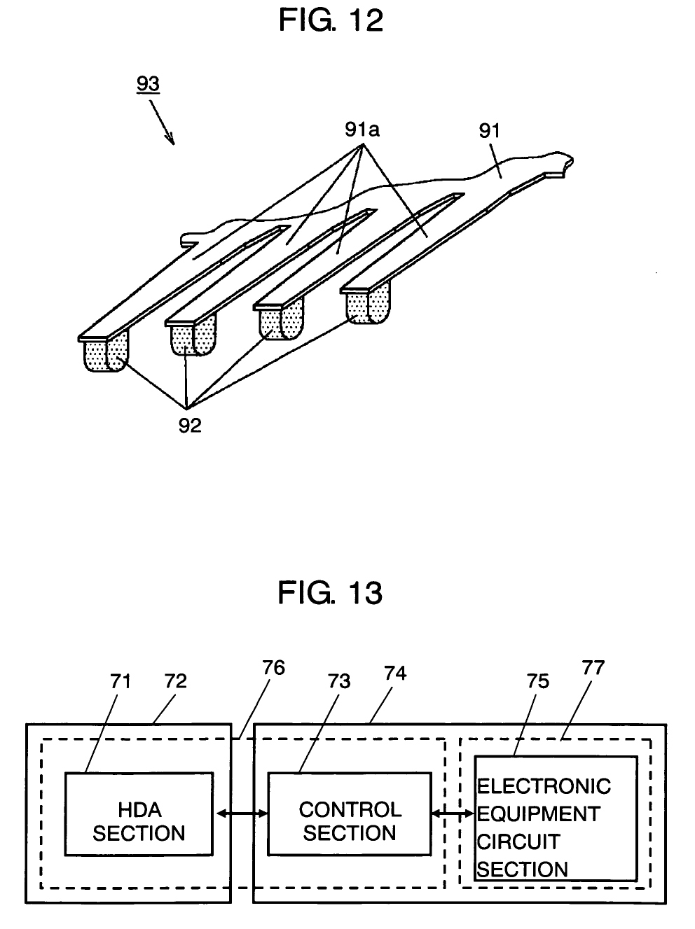

FIG. 1 is a plan view which shows a major configuration of magnetic disk device 11 in an embodiment of the present invention, and FIG. 2 is an expansion plan view which shows a configuration of its relay wiring body 7, and FIG. 3A is a side view on the occasion that relay wiring body 7 is assembled, and FIG. 3B is a side view in which a portion of a R portion in FIG. 3A of magnetic disk device 11 in the embodiment of the present invention is enlarged, and FIG. 3C is a cross sectional view of its FPC post 32, and FIG. 4A is a plan view which shows a configuration of its pressing elastic member 9, and FIG. 4B is a side view of pressing elastic member 9, and FIG. 5A is a partial cross sectional view which shows a cross section, at an A-A line in FIG. 1, of magnetic disk device 11, and FIG. 5B is a partial cross sectional view which shows a cross section at a B-O₁-O₂-O₃-B line in FIG. 1, and FIG. 6 is a partial cross sectional view which shows a cross section at a C-O₄-C line in FIG. 1, and FIG. 7 is a partial plan view of vicinity of a contact portion of relay wiring body 7 and motor wiring body 1a, of magnetic disk device 11 in the embodiment of the present invention, and FIG. 8 is a perspective view which shows a configuration of an assembly jig on the occasion of assembling magnetic disk device 11 in the embodiment of the present invention, and FIG. 9A through FIG. 11B are views for explaining processes of assembling magnetic disk device 11 in the embodiment of the present invention, and FIG. 12 is a partial perspective view which shows another example of pressing elastic member 9 of magnetic disk device 11 in the embodiment of the present invention.

FIG. 1 shows such a situation that upper side chassis 52 of magnetic disk device 11 is removed, and illustrates such a situation that upper side chassis 52 and an upper side yoke which is disposed on upper side chassis 52 are omitted. A housing of magnetic disk device 11 has upper side chassis 52 (also described as a first housing) and lower side chassis 10 (also described as a second housing).

Firstly, magnetic disk device 11 in the embodiment of the present invention is, as shown in FIG. 1, equipped with magnetic recording medium 3 which is supported rotatably by rotating center shaft 2 of spindle motor 1 that is a rotating portion, head supporting device (described as an actuator or an actuator portion) 5 which has a magnetic head, that is a signal conversion element for recording information on magnetic recording medium 3 and reproducing information recorded on magnetic recording medium, at its one end side, and is supported by turning shaft 4 so as to be able to be turned, and has tab portion 5b at its front edge, ramp block 6 which is disposed at a retracted position of actuator 5 and has a plurality of inclinatory inclined surfaces and a plurality of flat surfaces, relay wiring body (first wiring body) 7 on which preamplifier circuit section 7a, that is an amplification circuit for amplifying and taking out a reproduction signal from the magnetic head with high precision, is disposed, motor wiring body (second wiring body) 1a which supplies a drive electric current to spindle motor 1, actuator wiring body 5a which is formed integrally with relay wiring body 7 for giving and receiving a signal to and from the magnetic head that is disposed on one end side of actuator 5, and giving and receiving a signal to and from voice coil 8 which is disposed at the other end and is a turning portion for positioning of the magnetic head, and pressing elastic member 9 which is sandwiched by relay wiring body 7 and electrically connects relay wiring body 7 and motor wiring body 1a by a method which will be described later.

In addition, in magnetic disk device 11 in the embodiment of the present invention, the above-described each constituent element is stored in an inside of lower side chassis 10, and a control section, which controls each constituent element, is disposed on electric circuit main substrate 53 (not shown in FIG. 1, and see, FIG. 5B) which is separately disposed on an outside of the housing. The above-described example explained such an example that preamplifier circuit section 7a is disposed on relay wiring body 7, but preamplifier circuit section 7a may be mounted on electric circuit main substrate 53 which is separately disposed on an outside of the housing and relay wiring body 7 may be only a wiring portion which an electric signal simply passes through.

Next, relay wiring body 7 of magnetic disk device 11 in the embodiment of the present invention will be explained by use of FIG. 2. As shown in FIG. 2, relay wiring body 7 in the embodiment of the present invention is equipped with an electric wiring member like flexible wiring substrate (hereinafter, described as a FPC substrate) 21, electric circuit component 22 which configures an electric circuit such as preamplifier circuit section 7a disposed on FPC substrate 21, connector 23 which is electric signal sending means for being connected to electric circuit main substrate 53 (not shown in FIG. 2) disposed outside, and is a terminal portion, and gasket 24 for sealing a peripheral portion of connector 23 from outside air.

In addition, FPC substrate 21 of relay wiring body 7 of magnetic disk device 11 in the embodiment of the present invention is such an electric wiring member that electrically conductive portion 21b is formed by a predetermined pattern on base material portion 21 which is composed of an insulating material, and connecting portion 25, which is bifurcated into a plurality of pieces, is formed on a right side of FPC substrate 21 in FIG. 2. It is configured in such a manner that a front edge portion of connecting portion 25 of FPC substrate 21 is electrically conductive and is brought into contact with a plurality of electrically conductive portions 1b of corresponding motor wiring body 1a (see, FIG. 7) and connected electrically. In addition, to connector 23, wiring 57 extended from connecting portion 25 and wiring 56 extended from signal wiring connecting portion 5c are connected, respectively. In a region between wiring 56 and wiring 57 at a portion directly below connector 23, ground line portion 55 is disposed in a polyimide layer, and it is possible to prevent generation of cross talk between wiring 56 and wiring 57.

There is not necessarily such a necessity that the front edge portion of connecting portion 25 of FPC substrate 21 is of a bifurcated shape into a plurality of pieces, and it may be configured in such a manner that it is formed as an integrated shape, and a plurality of electrically conductive portions 21b are disposed on its front edge portion so as to correspond to each of electrically conductive portion 1b of motor wiring body 1a.

Further, in magnetic disk device 11 of the embodiment of the present invention, actuator wiring body 5a is formed on base material portion 21a of FPC substrate 21 of relay wiring body 7. In addition, through-hole 21c, which FPC post 32 (see FIG. 3A) passes through, in such a situation described later that FPC substrate 21 is folded back, is disposed in FPC substrate 21.

In addition, relay wiring body 7 in magnetic disk device 11 of the embodiment of the present invention is, as shown in FIGS. 3A and 3B, used in such a situation that relay wiring body 7 is folded by nearly 180° (mountain folding) so as to be opposed to base material portion 21a of FPC substrate 21, at a broken line X-X line in FIG. 2. In addition, it is used in such a situation that flat surface portion 9a of pressing elastic member 9 shown in FIG. 4A is sandwiched by FPC substrate 21, through two pieces of reinforcing plates 31 which are fixed to FPC substrate 21 for reinforcing FPC substrate 21 is formed and uses, for example a SUS plate material etc., and FPC substrate 21 is doubled.

As shown in FIGS. 3A and 3B, in magnetic disk device 11 of the embodiment of the present invention, it becomes such a situation that pressing elastic member 9 and two reinforcing plates 31 are bonded, when a double-sided adhesive tape etc. are applied on front-back both surfaces of flat surface portion 9a of pressing elastic member 9 and pressing elastic member 9 is sandwiched by two reinforcing plates 31 fixed to FPC substrate 21.

Next, pressing elastic member 9, which is a pressing portion of magnetic disk device 11 in the embodiment of the present invention, will be explained. Pressing elastic member 9, in magnetic disk device 11 in the embodiment of the present invention, has a shape as shown in FIGS. 4A and 4B and it is possible to manufacture it by use of an elastic material having a spring characteristic such as phosphor bronze. At one end portion of pressing elastic member 9, a plurality of bifurcated front edge portions 9b are formed, so as to correspond to each of a plurality of connecting portions 25 which are disposed at a front edge portion of FPC substrate 21. FIG. 4B is a side view viewed from a right direction of FIG. 4A, and front edge portion 9b is folded back in a direction heading for a paper surface, in FIG. 4A. By this means, it becomes possible for front edge portion 9b to give biasing force against connecting portion 25 of FPC substrate 21.

In addition, in pressing elastic member 9, through-hole 9c which FPC post 32, that will be described later, passes through and ramp post through-hole 9d which ramp post 61 passes through, positioning hole 9e of ramp block 6, through-holes 9f and 9g which two positioning protruding portions 51c of spacer 51 that will be described later, pass through, are formed.

In magnetic disk device 11 of the embodiment of the present invention, when relay wiring body 7 is disposed at a predetermined position to pressing elastic member 9, each of plural front edge portions 9b of pressing elastic member 9 pushes corresponding connecting portion 25 among a plurality of connecting portions 25 of FPC substrate 21, and they are brought into contact with a plurality of electrically conductive portions 1b (see FIG. 7) of motor wiring body 1a, and connecting portion 25 of FPC substrate 21 and electrically conductive portion 1b of motor wiring body 1a are electrically connected.

In order to restrain weakening of pressing force to connecting portion 25 by front edge portion 9b of pressing elastic member 9, by the force from an outside such as impact, especially impact in a rotating direction, it is desirable, as shown in FIG. 4A, that front edge portion 9b of pressing elastic member 9 is formed in such a manner that width 41b of a root portion becomes larger than width 41a of a front edge portion. That is, it is desirable to form it so as to satisfy

width 41a<width 41b.

In other words, front edge portion 9b of pressing elastic member 9 of magnetic disk device 11 in the embodiment of the present invention is formed in such a shape that its cross sectional area is made smaller from a portion of a root to a portion of a front edge.

Here, a configuration of periphery of FPC substrate 21 in magnetic disk device 11 in the embodiment of the present invention will be explained. In magnetic disk device 11 in the embodiment of the present invention, FPC post 32 has upper circular cylindrical portion 32c and lower circular cylindrical portion 32b, in which screw portion 32a is formed at a central portion, as shown in FIG. 3C, in such a situation that pressing elastic member 9 is sandwiched by relay wiring body 7, and lower circular cylindrical portion 32b of FPC post 32 is penetrated through through-hole 21c disposed in FPC substrate 21 and through-hole 9c of pressing elastic member 9.

Step surface 32d between upper circular cylindrical portion 32c and lower circular cylindrical portion 32b of FPC post 32 is brought into contact with FPC substrate 21, and FPC substrate 21 and FPC post 32 are solder-fixed at a boundary of upper circular cylindrical portion 32c and step surface 32d, i.e., over entire circumference of corner portion 32e. It is configured in such a manner that a wiring, which becomes GND, is formed on FPC substrate 21 at the soldering portion, and FPC substrate 21 becomes a ground line through FPC post 32, when magnetic disk device 11 is assembled. This ground line is connected to ground line portion 55.

Further, in magnetic disk device 11 in the embodiment of the present invention, signal wiring connecting portion 5c of actuator wiring body 5a formed integrally with relay wiring body 7 is folded by nearly 90° in a paper surface upper direction (valley folding direction) at a broken line Y-Y line shown in FIG. 2, and actuator wiring body 5a is folded by nearly 90° in a paper surface upper direction (valley folding direction) in FIG. 2 at a broken line Z-Z line.

By doing in this manner, it is possible to attach signal wiring connecting portion 5c in actuator wiring body 5a to lower side chassis 10 in the vicinity of actuator 5, as shown in FIG. 1, and to connect signal wirings from a magnetic head and voice coil 8.

Next, as shown in FIG. 5A, two pieces of positioning protruding portion 51a and positioning protruding portion 51b, which are disposed on spacer 51, are fitted in and positioned by 4 pieces of positioning holes 21d and positioning holes 21e (see, FIG. 2) which are disposed so as to be penetrated through FPC substrate 21 that is doubled by sandwiching pressing elastic member 9, and thereby, spacer 51 is mounted, and gasket 24, FPC substrate 21 which sandwiches pressing elastic member 9, and spacer 51 are sandwiched by lower side chassis 10 and upper side chassis 52, and thereby, it is possible to fix a position. Also in reinforcing plate 31, through-hole 31a and through-hole 31b are disposed, respectively, at positions which correspond to two pieces of positioning protruding portion 51a and positioning protruding portion 51b which are disposed on spacer 51, respectively.

In magnetic disk device 11 in the embodiment of the present invention, gasket 24 for sealing outside air is disposed at an external peripheral portion of connector 23 which is disposed on FPC substrate 21 of relay wiring body 7. As gasket 24, it is possible to use an elastic member such as a rubber material for keeping air tightness, e.g., silicon rubber (hardness 55°).

In addition, as shown in FIG. 5B, in magnetic disk device 11 in the embodiment of the present invention, a contact surface of protruding portion 51 which is disposed on one end surface of spacer 51 contacts FPC substrate 21, at a corresponding position on the opposite side to FPC substrate 21, of such a position that FPC substrate and gasket 24 contact, by carrying out positioning of a position of spacer 51 to FPC substrate 21. Therefore, spacer 51, FPC substrate 21 and gasket 24 of connector 23 are sandwiched by lower side chassis 10 and upper side chassis 52, and thereby, it is possible to keep air tightness by gasket 24, more surely.

By inserting connector 54 on electric circuit main substrate 53 which is disposed on an outside of lower side chassis 10 of magnetic disk device 11, into connector 23 which is disposed on FPC substrate 21, it is possible to connect relay wiring body 7 and electric circuit main substrate 53.

A contact surface of spacer 51 and FPC substrate 21 may be of a hollow rectangular shape which is nearly the same as a contact surface of gasket 24 and FPC substrate 21, and a surface of partially contacting at plural places at a corresponding position on the opposite side to FPC substrate 21, of the contact surface of gasket 24 and FPC substrate 21.

Further, in magnetic disk device 11 of the embodiment of the present invention, in order to keep its air tightness by gasket 24, it is desirable to configure in such a manner that a female type connector is used as connector 23 and gasket 24 is fitted in its outside.

Further, in magnetic disk device 11 of the embodiment of the present invention, in order to avoid contact of electric circuit components 22 which configure a circuit such as a preamplifier circuit section 7a which is disposed on FPC substrate 21 and spacer 51, spacer 51 is formed so as to have a space at a portion on FPC substrate 21 where electronic circuit component 22 is disposed.

Here, a configuration of periphery of ramp block 6 of magnetic disk device 11 in the embodiment of the present invention will be explained. In pressing elastic member 9 of magnetic disk device 11 of the embodiment of the present invention, as shown in FIG. 6, ramp post through-hole 9d which lower circular cylindrical portion 61 of ramp post 61, where screw portion 61a is formed at a central portion, passes through, and positioning hole 9e for carrying out positioning of ramp block 6 are disposed (see, FIG. 4A).

In ramp block 6 of magnetic disk device 11 in the embodiment of the present invention, positioning protruding portion 6a is disposed at such a position that it is fitted in positioning hole 9e of pressing elastic member 9, and positioning hole 6b as is fitted in upper circular cylindrical portion 61c of ramp post 61 is disposed.

At the time of assembly of magnetic disk device 11, it is possible to mount ramp post 61 on pressing elastic member 9 so as to arrange in such a manner that lower circular cylindrical portion 61b of ramp post 61 passes through ramp post through-hole 9d of pressing elastic member 9.

After that, positioning hole 6b of ramp block 6 is fitted in upper circular cylindrical portion 61c of ramp post 61, and positioning protruding portion 6a of ramp block 6 is fitted in positioning hole 9e of pressing elastic member 9, and ramp block 6 is mounted on upper step surface 61e of flange portion 61d of ramp post 61, and thereby, it is possible to determine a position of ramp block 6 to pressing elastic member 9. Further, passing through through-hole 52a of upper side chassis 52, screw 62 tights up ramp block 6 toward screw portion 61a at a central portion of ramp post 61. By this means, ramp block 6 is sandwiched between upper side chassis 52 and upper step surface 61e of flange portion 61d of ramp post 61, and fixed.

Further, lower side chassis 10 and ramp post 61 are fastened by screw 63 through through-hole 10a of lower side chassis 10, by using screw portion 61a at a central portion of ramp post 61 as a penetrating screw portion. As shown in FIG. 6, ramp post 61 is fixed to upper side chassis 52 and lower side chassis 10 at its upper and lower ends, and thereby, it is possible to carry out positioning of ramp block 6 at a predetermined position. By this means, a position of relay wiring body 7 is also determined.

Further, in magnetic disk device 11 in the embodiment of the present invention, although it is not shown in the figure here, a penetrating screw portion, which is the same as screw portion 61a of ramp post 61, is disposed also at a central portion of turning shaft 4 of actuator 5, and upper side chassis 52 and lower side chassis 10 are fixed to each other by screws 64 through through-holes disposed in the respective chassises, and thereby, it is possible to carry out positioning of actuator 5 at a predetermined position.

As described previously, in magnetic disk device 11 in the embodiment of the present invention, by fixing FPC post 32 and ramp post 61 to upper side chassis 52 and lower side chassis 10, a positional relation of FPC substrate 21 of relay wiring body 7 to motor wiring body 1a which is disposed on spindle motor 1 attached to lower side chassis 10, as shown in FIG. 7, is determined, and a plurality of connecting portions 25, which are disposed at a front edge of relay wiring body 7, are pressed by biasing force of pressing elastic member 9 in a direction heading for a paper surface, and thereby, they are brought into contact with a plurality of electrically conductive portions 1b on motor wiring body 1a, respectively, and it is possible to carry out giving and receiving an electric signal.

In addition, in magnetic disk device 11 in the embodiment of the present invention, as shown in FIG. 7, in the vicinity of such portions that a plurality of connecting portions 25 of FPC substrate 21, which is pressed by pressing elastic member 9 and configures relay wiring body 7, contact a plurality of electrically conductive portions 1b of motor wiring body 1a, respectively, width W₁ of connecting portion 25 of FPC substrate 21, which contacts electrically conductive portion 1b of motor wiring body 1a, is smaller than width W₂ of electrically conductive portion 1b of motor wiring body 1a. Further, it is desirable from the viewpoints of impact resistance and stability, to form it in such a manner that width W₁ of connecting portion 25 becomes larger than at least width W₃ of front edge portion 9b of pressing elastic member 9 which presses connecting portion 25 of FPC substrate 21. That is, by setting respective widths W₁, W₂ and W₃ so as to satisfy

W₂>W₁≧W₃,

even if a center of width W₁ of electrically conductive portion 21b at each connecting portion 25 of FPC substrate 21, a center of width W₂ of each electrically conductive portion 1b of motor wiring body 1a, and a center of width W₃ of front edge portion 9b of pressing elastic member 9 are slightly deviated one another, respective contacts of respective electrically conductive portions 1b of motor wiring body 1a and respective connecting portions 25 of FPC substrate 21 which correspond to them are ensured, and there is not such a case that that respective slight mounting position displacements of FPC substrate 21 and pressing elastic member 9 to motor wiring body 1a bring about obstacles to giving and receiving an electric signal due to a contact of motor wiring body 1a and FPC substrate 21.

In addition, in such a portion that electrically conductive portion 1b of motor wiring body 1a of magnetic disk device 11 in the embodiment of the present invention contacts connecting portion 25 of FPC substrate 21, by applying gold plating to vicinity of at least such portions that electrically conductive portions 1b and connecting portions 25 contact, respectively, it is possible to make contact resistance nearly 0Ω. By this means, even if contact pressure of electrically conductive portion 1b and connecting portion 25 is changed by impact from an outside and vibration etc., it is possible to keep nearly 0Ω, as long as contact is maintained, without changing the contact resistance.

As described above, according to magnetic disk device 11 in the embodiment of the present invention, electrically conductive portion 1b of motor wiring body 1a and connecting portion 25 of FPC substrate 21 are brought into contact by pressing of front edge portion 9b of pressing elastic member 9 and connected electrically, and therefore, for example, on the occasion of exchanging spindle motor 1 due to failure, a troublesome work of removing fixing by soldering etc. becomes unnecessary, and it becomes possible to realize improvement of a re-work characteristic.

The embodiment of the present invention showed such an example that wiring 57 from motor wiring body 1a, wiring 56 from signal wiring connecting portion 5c and connector 23 are formed integrally with relay wiring body 7 of magnetic disk device 11, but the present invention is not limited to this example, and for example, motor wiring body 1a, relay wiring body 7 and connector 23 may be configured separately, respectively.

Next, an assembling method of a disk drive portion (a portion excluding electric circuit main substrate 53 from the configuration of magnetic disk device 11) of magnetic disk device 11 in the above-described embodiment of the present invention will be explained.

Firstly, assembly jig 81 as shown in FIG. 8 is prepared. In assembly jig 81, actuator positioning post 82 which carries out positioning of actuator 5 by being fitted in a screw hole of a penetrating screw portion of turning shaft 4 of actuator 5, FPC positioning post 83 which is fitted in screw portion 32a of FPC post 32 for determining one position of relay wiring body 7, and ramp positioning post 84 which is fitted in a screw hole of screw portion 61a of ramp post 61 for carrying out positioning of the other position of relay wiring body 7 and a position of ramp block 6, are disposed on substrate 85 at predetermined positions, respectively. In addition, in assembly jig 81, clearance hole 106 of connector 23 in case that relay wiring body 7 is mounted, is disposed.

Firstly, as a first process, as shown in FIG. 9A, a screw hole of screw portion 32a of FPC post 32, which is solder-fixed to relay wiring body 7 sandwiching pressing elastic member 9, is fitted and inserted in FPC positioning post 83 disposed on assembly jig 81, and ramp post through-hole 9d of elastic pressing member 9 is inserted in ramp positioning post 84.

Next, as a second process, as shown in 9B, spacer 51 is mounted on relay wiring body 7 to which FPC post 32 is solder-fixed. Positioning protruding portion 51a and positioning protruding portion 51b at two places, which are disposed on spacer 51, are fitted and inserted in two positioning hole 21d and positioning hole 21e of relay wiring body 7, and thereby, spacer 51 is positioned and mounted on relay wiring body 7.

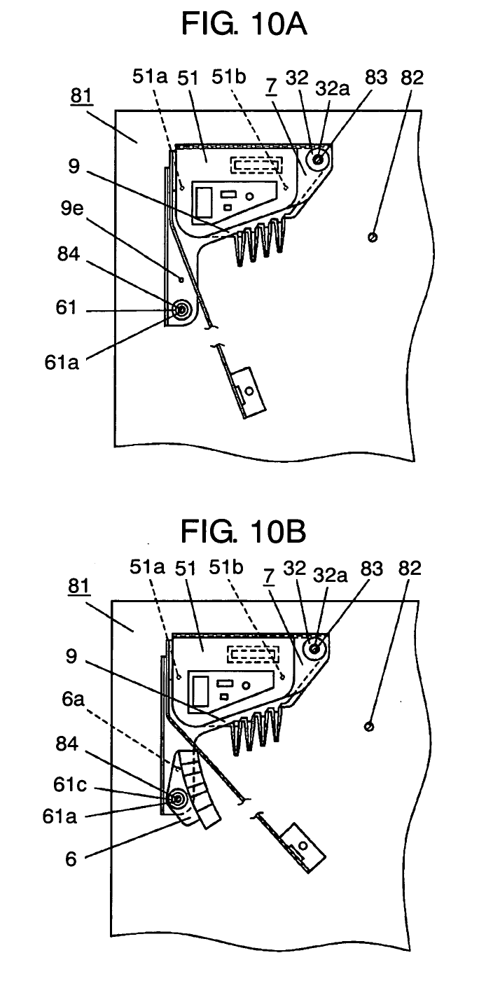

In addition, as a third process, as shown in FIG. 10A, lower circular cylindrical portion 61b of ramp post 61 is penetrated through ramp post through-hole 9d of pressing elastic member 9 sandwiched by relay wiring body 7 which is mounted on assembly jig 81, and a screw hole of screw portion 61a of ramp post 61 is fitted and inserted in ramp positioning post 84 which is disposed on assembly jig 81.

Further, as a fourth process, as shown in FIG. 10B, positioning hole 6b of ramp block 6 is fitted in upper circular cylindrical portion 61c of ramp post 61 which is assembled on assembly jig 81, and positioning protruding portion 6a of ramp block 6 is fitted in positioning hole 9e of pressing elastic member 9, and thereby, ramp block 6 is positioned and mounted on upper step surface 61e of flange portion 61d of ramp post 61.

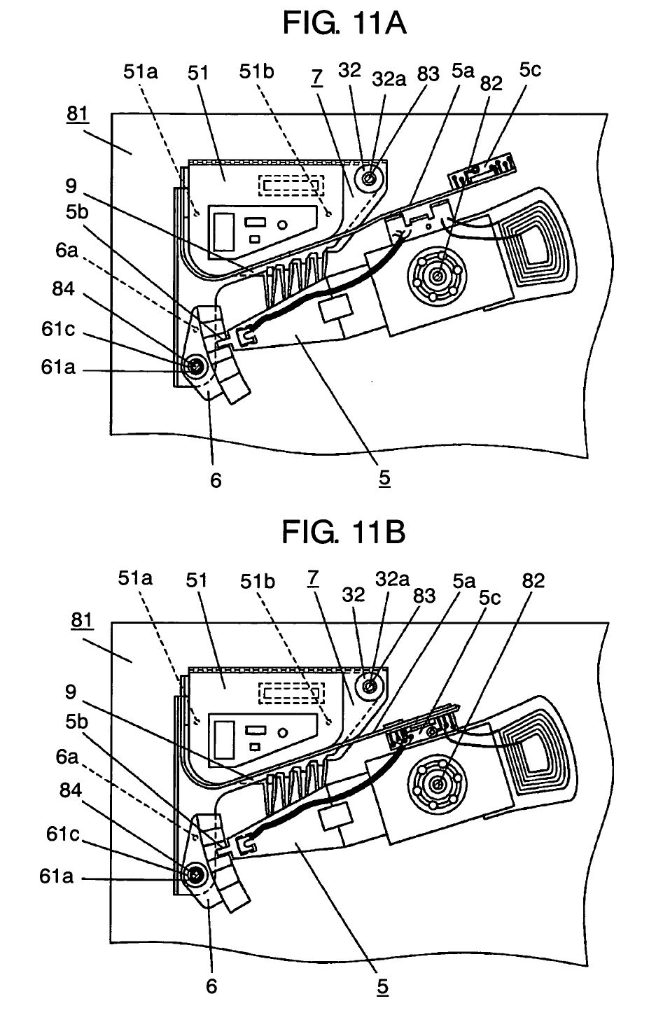

Next, as a fifth process, as shown in FIG. 11A, a penetrating screw portion of turning shaft 4 of actuator 5 is fitted and inserted in actuator positioning post 82 which is disposed on assembly jig 81, and tab portion 5b, which is disposed on a front edge of actuator 5, is arranged to be positioned at a retracted position of ramp block 6, and thereby, actuator 5 is positioned and mounted on assembly jig 81.

Further, as a sixth process, as shown in FIG. 11B, signal wiring connecting portion 5c, which is disposed on an end portion of actuator wiring body 5a formed integrally with relay wiring body 7 and folded by nearly 90° at a Y-Y line shown in FIG. 2, is attached to a predetermined position of actuator 5, and signal wirings from a magnetic head and voice coil 8, which are disposed on actuator 5, are connected to signal wiring connecting portion 5c, respectively.

The sixth process explained a method of disposing signal wiring connecting portion 5c, which is disposed on an end portion of actuator wiring body 5a, at a predetermined position of actuator 5 and connecting respective signal wirings from the magnetic head and voice coil 8, which are disposed on actuator 5, to signal wiring connecting portion 5c, but it may be configured in such a manner that, to get things started, respective signal wirings from the magnetic head and voice coil 8, which are disposed on actuator 5, are connected to signal wiring connecting portion 5c of actuator wiring body 5a, and thereafter, signal wiring connecting portion 5c is connected to actuator 5. In the suchlike method, by firstly connecting respective signal wirings to signal wiring connecting portion 5c, a wiring from a magnet head to a head amplifier becomes a closed circuit, and therefore, it is possible to prevent occurrence of such a trouble that a magnetic head is broken in consequence of static electricity etc.

Next, as a seventh process, upper side chassis 52 is mounted on spacer 51 mounted on relay wiring body 7, FPC post 32 solder-fixed to relay wiring body 7, ramp block 6 mounted on upper step surface 61e of ramp post 61, and turning shaft 4 of actuator 5 mounted on a predetermined position, and it is fixed with screw cramp by inserting screws in respective screw portions (61a, 32a) of turning shaft 4, ramp post 61 and EPC post 32, through respective hole portions disposed in upper side chassis 52, to form an upper side housing (first housing).

For practical purposes, it is desirable to configure in such a manner that a hole portion of upper side chassis 52, which is used on the occasion of fixing FPC post 32, is formed as a hole portion having an allowance to a screw external diameter such as a long hole, and at the time of assembly, turning shaft 4 and ramp post 61 are firstly fastened to upper side chassis 52, and then, EPC post 32 is fixed to upper side chassis 52.

Next, as an eighth process, the upper side housing, which is assembled in the above-described seventh process, is mounted on a lower side housing (second housing) in which spindle motor 1 is attached to a predetermined position of lower side chassis 10 and motor wiring body 1a is disposed at a predetermined position, to thereby finish a disk drive section of magnetic disk device 11.

As described above, in magnetic disk device 11 in the embodiment of the present invention, by carrying out the suchlike assembly, connecting portion 25 of FPC substrate 21 pressed by front edge portion 9b of pressing elastic member 9 is brought into contact with electrically conductive portion 1b in motor wiring body 1a disposed on lower side chassis 10, and electric connection is formed between electrically conductive portion 21b in connecting portion 25 of FPC substrate 21 and electrically conductive portion 1b of motor wiring body 1a.

Although an explanation is omitted in the above-described explanation of the assembling method of the magnetic disk device, constituent members, which are necessary for the disk drive section such as an upper side yoke, a lower side yoke and a permanent magnet for configuring a voice coil motor, are incorporated in the upper side housing and the lower side housing.

In addition, in magnetic disk device 11 in the embodiment of the present invention, in reverse to assembly, at the time of disassembling what was assembled, it becomes possible to easily remove electrically conductive portion 1b of motor wiring body 1a of spindle motor 1 attached to lower side chassis 10, from connecting portion 25 of FPC substrate 21 of relay wiring body 7 attached to upper side chassis 52, by removing the lower side housing from the upper side housing, and it is possible to easily separate spindle motor 1 and actuator 5.

The above-described explanation was described in such a manner that pressing elastic member 9 is formed by an elastic material, and front edge portion 9b, which presses connecting portion 25 of FPC substrate 21, is formed integrally with pressing elastic member 9, but the present invention is not limited to this. For example, as shown in FIG. 12, it is also possible to use such pressing elastic member 93 that elastic portions 92 having elasticity such as a rubber material and a cushion material are disposed on a plurality of bifurcation portions 91a disposed on base material portion 91 using a flat plate material such as SUS. Even when it is configured like pressing elastic member 93, respective bifurcation portions 91a are formed in such a manner like front edge portion 9b of pressing elastic member 9 described above that a cross sectional area of a front edge portion becomes smaller than a cross sectional area of a root portion, and thereby, it is possible to configure with high impact resistance and high stability against displacement on the occasion of assembly. In addition, as bifurcation portion 91a, it is also possible to use a so-called plate spring member such as SUS, and it is possible to use an elastic member such as rubber.

As described above, according to magnetic disk device 11 in the embodiment of the present invention, it is possible to connect electric wirings for giving and receiving an electric signal between electric circuit main substrate 53 and the disk drive section of magnetic disk device 11 through one connector 23, and therefore, it is possible to realize a disk device at low cost. In addition, according to magnetic disk device 11 in the embodiment of the present invention, it is possible to give and receive an electric signal from electric circuit main substrate 53, by pressing connecting portion 25 of relay wiring body 7 to electrically conductive portion 1b of motor wiring body 1a of spindle motor 1 and contacting them, and therefore, it is possible to easily carry out disassembly and assembly, at the time that any trouble occurred in a constituent component of the disk drive section, even at the time of exchange of a damaged component.

In the embodiment of the present invention, the explanation was carried out by using a configuration of magnetic disk device as an example of a disk device, but a disk device of the present invention is not limited to this at any rate, and for example, it is also applicable to another non-contact type disk device such as a DVD device, a magnetic optical disk device and an optical disk device.

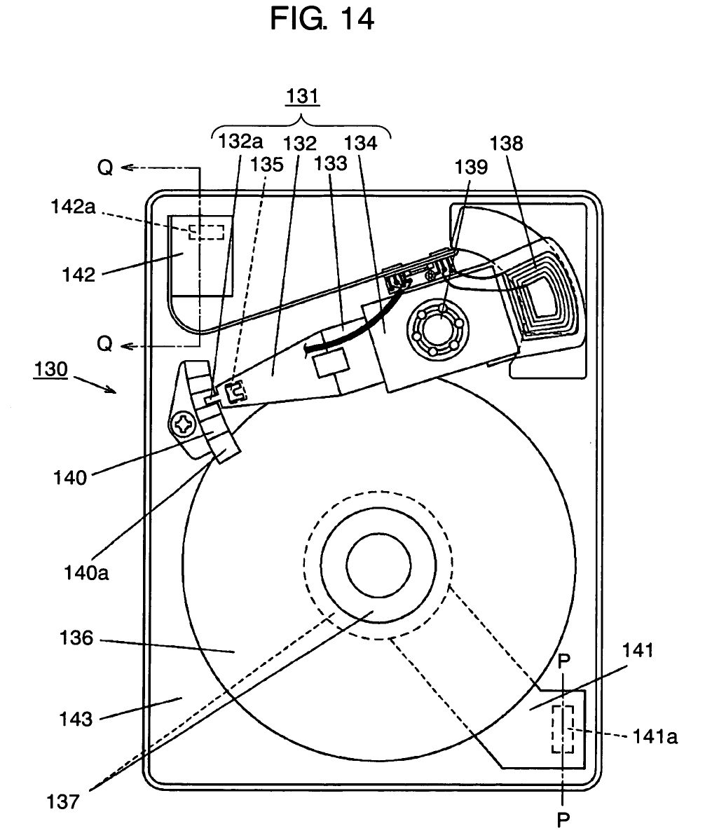

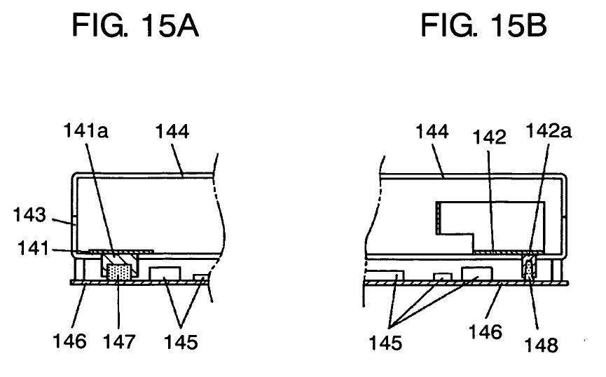

Further, if an electronic equipment such as a portable telephone device, a portable audio player device, a disk reproducing device or a disk recording device is configured by incorporating the disk device of the present invention therein, it is possible to realize such a configuration that it is much easier to connect. FIG. 13 is a block diagram which shows a configuration of an electronic equipment in which the disk device in the embodiment of the present invention is incorporated.

As shown in FIG. 13, in electronic equipment 74 in the embodiment of the present invention, HDA (Head Disk Assembly or Hard Disk Assembly) section 71 excluding the control section from the configuration of above-described magnetic disk device 11 configures disk unit 72, and control section 73 for controlling HDA section 71 and electronic equipment circuit section 75 are disposed on electronic equipment 74. Disk unit 72 is attached to electronic equipment 74. In the suchlike configuration, HDA section 71 of disk unit 72 and control section 73 of electronic equipment 74 are connected by one terminal portion, and therefore, it is possible to easily carry out connection. Further, according to the disk device of the present invention, it is possible to dispose control section 73 of electronic equipment 74 and electronic equipment circuit section 75 on such a portion that a plurality of connector are disposed in a conventional disk device (e.g., lower both side portions of magnetic recording medium 3 in FIG. 1), and it is possible to realize miniaturization of a configuration.

As shown by a broken line of FIG. 13, it is also possible to configure in such a manner that disk unit 76 has HDA section 71 and control section 73 and electronic equipment 77 has electronic equipment circuit section 75.

### INDUSTRIAL APPLICABILITY

As described above, according to the present invention, it is possible to carry out connection to an outside by one connector, and therefore, it is possible to perform such a particular advantage that miniaturization of an entire device is possible and it is possible to realize a low cost disk device, and therefore, it is useful as a disk device which is equipped with a floating type signal conversion element, especially, a disk device which is controlled by a control section disposed outside a housing of a disk device, and an electronic equipment using it, etc.

1. A disk device comprising:
a housing;
a disk-shaped recording medium,
a rotating portion which rotates the recording medium,
a head portion which carries out at least any one of recording and reproducing of information to the recording medium,
an actuator portion which supports the head portion and can be turned in a radius direction of the recording medium;
a turning portion which turns the actuator portion so as to dispose the head portion on the recording medium at a desired position,
a first wiring body which is connected to the head portion and the turning portion electrically, and a second wiring body which is connected to the rotating portion electrically, in the housing; and
a control section, which carries out control of the rotating portion, the head portion and the turning portion, outside the housing,
wherein the first wiring body and the second wiring body are electrically connected in the housing, and
wherein a terminal is disposed on the housing for giving and receiving an electronic signal between the first wiring body, the second wiring body and the control section.

2. The disk device of claim 1, wherein the first wiring body has a connecting portion for being electrically connected to the second wiring body, and
the second wiring body has an electrically conductive portion for being electrically connected to the connecting portion of the first wiring body, at its end portion, and
a pressing portion, which presses in a direction of having the connecting portion of the first wiring body accessed to the electrically conductive portion of the second wiring body, is provided, and
the connecting portion of the first wiring body and the electrically conductive portion of the second wiring body are brought into contact, by pressing of the pressing portion, and the first wiring body and the second wiring body are connected electrically.

3. The disk device of claim 1, wherein the first wiring body has an amplification circuit of a signal which is outputted from the head portion.

4. The disk device of claim 2, wherein width W₁ and width W₂ are different in such a portion that the connecting portion of the first wiring body and the electrically conductive portion of the second wiring body contact.

5. The disk device of claim 4, wherein width W₁ of the connecting portion and width W₂ of the electrically conductive portion have a relation of
W₁<W₂.

6. The disk device of claim 2, wherein gold plating is formed on surfaces of the connecting portion and the electrically conductive portion, respectively, at portions where the connecting portion of the first wiring body and the electrically conductive portion of the second wiring body contact with each other.

7. The disk device of claim 2, wherein the pressing portion is formed by an elastic material, and has a plurality of bifurcated front edge portions, and the front edge portion presses the connecting portion of the first wiring body.

8. The disk device of claim 7, wherein the front edge portion of the pressing portion is of such a shape that a cross sectional area of a portion of a front edge is made smaller than a cross sectional area of a portion of a root.

9. The disk device of claim 2, wherein the pressing portion has a base material portion using a flat member, a plurality of bifurcation portions which are disposed on the base material portion, and elastic portions at portions of front edges of the respective plural bifurcation portions.

10. The disk device of claim 9, wherein each of the plural bifurcation portions of the pressing portion is of such a shape that a cross sectional area of a portion of a front edge is made smaller than a cross sectional area of a portion of a root.

11. The disk device of claim 2, wherein the first wiring body is folded and thereby, the pressing portion is sandwiched.

12. The disk device of claim 1, wherein the terminal portion is disposed on the first wiring body, and a wiring from the second wiring body and a wiring from the head portion and the turning portion are formed integrally on the first wiring body.

13. The disk device of claim 12, wherein a ground line portion is provided on the first wiring body between the wiring from the second wiring body and the wiring from the head portion and the turning portion.

14. The disk device of claim 2, wherein the housing is equipped with a first housing to which the first wiring body and the pressing portion are attached, and a second housing to which the rotating portion and the second wiring body are attached, and by assembling the first housing and the second housing, the first wiring body and the second wiring body are brought into contact, and the first wiring body is pressed to the second wiring body due to biasing force of the pressing portion, and thereby, the first wiring body and the second wiring body are connected electrically.

15. An electronic equipment comprising the disk device of claim 1.

16. The electronic equipment of claim 15, wherein the control section is disposed on the side of the electronic equipment.
